(19) United States
(12) Patent Application Publication
(10) Pub. No.: US 2011/0051194 A1
(43) Pub. Date: Mar. 3, 2011

(54) IMAGE FORMING APPARATUS AND METHOD THEREOF

(75) Inventor: Masahito Numata, Kawasaki-shi (JP)

(73) Assignee: CANON KABUSHIKI KAISHA, Tokyo (JP)

(21) Appl. No.: 12/860,271

(22) Filed: Aug. 20, 2010

(30) Foreign Application Priority Data
Aug. 28, 2009 (JP) 2009-198784

(51) Int. Cl. G06K 15/00

(52) U.S. Cl. 358/1.16

(57) ABSTRACT

An apparatus includes an output unit configured to periodically output a file to a storage region of a storage device and to share the storage region with another apparatus, a check unit configured to check whether a periodical output of the file to the storage region performed by a plurality of apparatuses is successful based on a number of the files stored in the storage region, and a post-processing unit configured to perform post-processing based on a result of the check performed by the check unit.

### BACKGROUND OF THE INVENTION

1. Field of the Invention

The present invention relates to a technique for dealing with history information about an image forming apparatus.

2. Description of the Related Art

Conventional image forming apparatuses including multifunction peripherals have a function of outputting histories about jobs, histories about operations, and information about various types of settings, in other words information stored in the multifunction peripherals, into files at each periodical interval. In an environment in which a plurality of multifunction peripherals is managed, destinations to which files are output from the multifunction peripherals are unified to analyze the output files.

However, when a power of the multifunction peripheral is off, or when the multifunction peripheral is in an abnormal state, it may fail to periodically output a file. Further, when a large number of multifunction peripherals are managed, it can be a troublesome job for a user to check whether the files have been correctly output from all the multifunction peripherals.

In recent years, a technique has been discussed in which data managing software that operating on a client's side apparatus monitors a shared folder in a file server connected via a local area network (LAN) and notifies a user if contents of the shared folder is changed (e.g., refer to Japanese Patent Application Laid-Open No. 2005-301689).

However, according to the technique described in Japanese Patent Application Laid-Open No. 2005-301689, the client apparatus which includes data managing software specialized for monitoring the shared folder is to be used, and the data managing software is to be activated when the files are periodically output. Therefore, when the data managing software is not activated, or when the data management software is in an abnormal state, it can be hardly detected whether the files are being periodically output.

### SUMMARY OF THE INVENTION

According to an aspect of the present invention, an apparatus includes an output unit configured to periodically output a file to a storage region of a storage device and to share the storage region with another apparatus, a check unit configured to check whether a periodical output of the file to the storage region performed by a plurality of apparatuses is successful based on a number of the files stored in the storage region, and a post-processing unit configured to perform post-processing based on a result of the check performed by the check unit.

Further features and aspects of the present invention will become apparent from the following detailed description of exemplary embodiments with reference to the attached drawings.

### BRIEF DESCRIPTION OF THE DRAWINGS

The accompanying drawings, which are incorporated in and constitute a part of the specification, illustrate exemplary embodiments, features, and aspects of the invention and, together with the description, serve to explain the principles of the invention.

FIG. 1 illustrates a configuration of a system.

FIG. 2 illustrates storage regions of a file server.

FIG. 3 illustrates an example for setting an application unit.

FIG. 4 illustrates an example for setting a periodical file output.

FIG. 5 illustrates an example for setting a periodical file output check.

FIG. 6 illustrates an example for setting post-processing.

FIG. 7 illustrates the storage regions in the file server after the post-processing has been performed.

FIG. 8 (including FIGS. 8A and 8B) is a flowchart illustrating processing for outputting the files.

### DESCRIPTION OF THE EMBODIMENTS

Various exemplary embodiments, features, and aspects of the invention will be described in detail below with reference to the drawings.

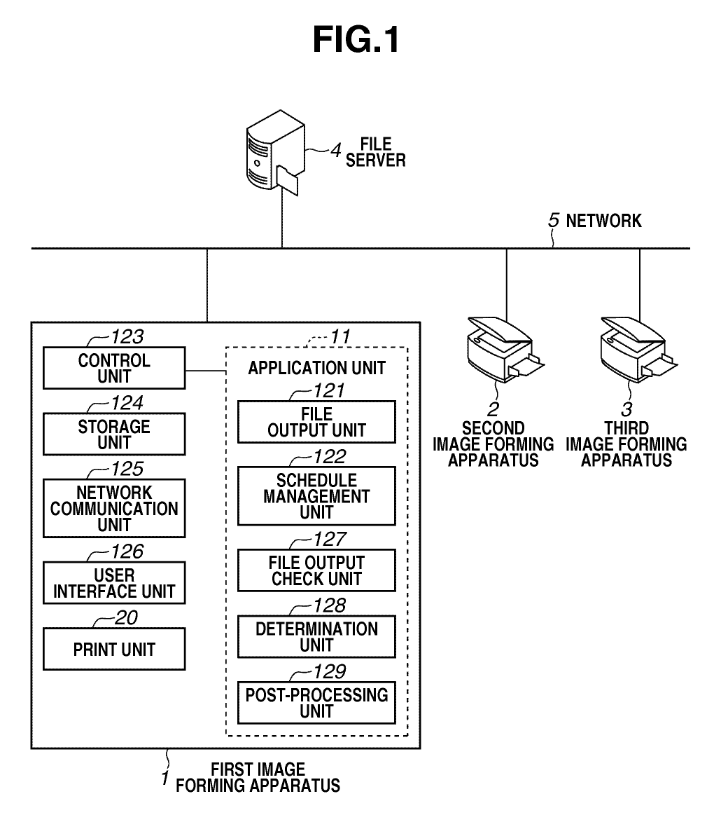

FIG. 1 illustrates a configuration of a system according to an exemplary embodiment. The system includes a plurality of image forming apparatuses (a first image forming apparatus 1, a second image forming apparatus 2, and a third image forming apparatus 3) and a file server 4 which is an example of a storage device. The image forming apparatus 1, the image forming apparatus 2, the image forming apparatus 3 and the file server 4 are communicably connected with each other via a network 5.

Each of the image forming apparatus 1, the image forming apparatus 2, and the image forming apparatus 3 has a similar configuration, and, for example, realizes an application unit 11 described below. The file server 4 includes a shared storage region capable of storing files output from the plurality of image forming apparatuses. The file server 4 is not limited to the file server. In other words, the file server 4 may be a fourth image forming apparatus (not illustrated) including a storage unit or a storage server on the Internet. The network 5 may be, for example, the LAN, a wireless LAN, or the Internet.

The present exemplary embodiment describes a system in which the application unit 11 realized by each of the plurality of the image forming apparatuses outputs to the file server 4 information about a history of the image forming apparatus in which the application unit 11 is included (history information corresponding to the image forming processing) as a data file at a periodical interval which is common to the image forming apparatuses and set in advance.

The image forming apparatus 1 includes a print unit 20, a control unit 123 (e.g., central processing unit (CPU)), a storage unit 124 (e.g., memory, hard disk drive (HDD)), a network communication unit 125, and a user interface unit 126.

The control unit 123 controls entire operations performed by the image forming apparatus. The storage unit 124 stores information about processing performed by the application unit 11, and information about processing other than processing performed by the application unit 11, in other words, information that can be used in the image forming apparatus are stored. The storage unit 124 may include an external storage apparatus such as an external HDD, and an external universal serial bus (USB).

The network communication unit 125 is connected to the network 5 to receive data from external apparatuses and to transmit data to the external apparatuses. The user interface unit 126 includes a keyboard, a mouse, a display, and the like, and receives an instruction from a user, and displays data (e.g., screen data).

When the control unit 123 performs processing according to a procedure of a program stored in the storage unit 124, for example, processing performed by the application unit 11 according to a flowchart described below can be realized.

Similar to the image forming apparatus 1, each of the file server 4 and an information terminal device described below includes a control unit and a storage unit. When the control unit performs processing according to a procedure of a program stored in the storage unit, a function of the file server 4 such as a storage function and a function of each information terminal device can be realized.

The application unit 11 includes a file output unit 121, a schedule management unit 122, a file output check unit 127, a determination unit 128, and a post-processing unit 129. In the present exemplary embodiment, only the application unit 11 is illustrated, however, a plurality of applications may be included.

The file output unit 121 acquires information stored in the storage unit 124, and outputs the information as a data file. Further, the file output unit 121 outputs the data file to the file server 4 via the network communication unit 125 and the network 5. More specifically, the file output unit 121 outputs the information stored in the storage unit 124 as the data file (hereafter, referred to as “file output”).

The schedule management unit 122 detects that a previously set periodical interval has elapsed and previously set time has come. For example, there is a detection method performed by monitoring a clock (not illustrated) in the image forming apparatus, and a method performed by the application unit 11 measuring an elapsed time if the clock is not provided. An adequate detection method can be adopted.

According to the present exemplary embodiment, when the schedule management unit 122 detects that the previously set periodical interval has elapsed, the file output unit 121 outputs a file to the file server 4.

However, the application unit 11 cannot output the file in a certain aspect. A certain aspect is, for example, a case where the application unit 11 is in an abnormal state, when the image forming apparatus 1 is in the abnormal state, when a power of the image forming apparatus 1 is off when the periodical interval has elapsed, and when the image forming apparatus 1 is in a power saving mode when the periodical interval has elapsed.

In the present exemplary embodiment, a case where the file output unit 121 cannot output the file when the periodical interval has elapsed is referred to as “file output failure”.

The file output check unit 127 checks the number of the files output to the storage region in the file server 4 at every periodical interval, determines whether an image forming apparatus that has failed the file output exists among the plurality of image forming apparatuses, and checks whether the file is successfully output at the periodical interval (the periodical output is successful). In the present exemplary embodiment, performing the periodical output check of success is referred to as a “file output check”.

The determination unit 128 determines whether the image forming apparatus in which the determination unit 128 is included (image forming apparatus 1) is to perform the file output check among the plurality of image forming apparatuses. When the image forming apparatus in which the determination unit 128 is included corresponds to any one of the image forming apparatuses described below, the determination unit 128 determines that the own image forming apparatus performs the file output check. As for a determination method to be performed by the determination unit 128, appropriate methods can be combined for use.
An image forming apparatus that has first output a file during the periodical file output of the present time
An image forming apparatus that has newly output the file to the storage region in which the file output check has been already completed
An image forming apparatus that has detected existence of a storage region whose suspension expired

The post-processing unit 129 performs previously set post-processing according to a result of the file output check. For example, the post-processing unit 129 notifies a user of the result of the file output check and changes an attribute value of the file stored in the storage region in the file server 4 according to the result of the file output check.

Considering the above description, outlines of operations performed by the application unit 11 will be described. When the schedule management unit 122 detects that the periodical interval has elapsed, the file output unit 121 outputs the file to the storage region in the file server 4. The determination unit 128 determines whether the image forming apparatus in which the determination unit 128 is included (i.e., the application init 11) is the image forming apparatus (application) to perform the file output check. When the determination unit 128 determines that the image forming apparatus in which the determination unit 128 is included is the apparatus to perform the file output check, the file output check unit 127 performs the file output check. Finally, the post-processing unit 129 performs the post-processing based on the results of the file output check.

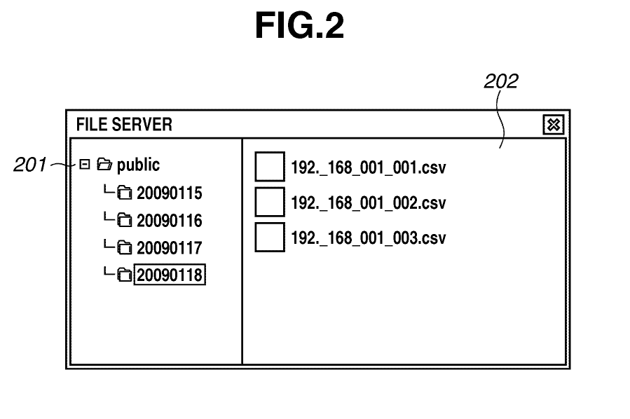

FIG. 2 illustrates an example of a screen indicating the storage regions in the file server 4.

The storage region display unit 201 displays a structure of the storage region in the file server 4. According to the present exemplary embodiment, the periodical interval of the file output is set to once a day, and the application unit 11 generates a folder having a name representing a date when the file is output at each periodical interval. The processing performed by the file server 4 can be realized when the application unit 11 gives an instruction to the file server 4. For example, generation of the folder is realized in a manner such that the application unit 11 transmits information about the instruction to generate the folder to the file server 4 via the network 5, and the file server 4 that has received the information generates the folder.

A stored file display unit 202 displays a list of files stored in the storage region in the file server 4. According to the present invention, the application unit 11 generates the file having an Internet protocol (IP) address of the image forming apparatus 1 as a file name (in this example, “csv” is used as an extension) and outputs the files.

The storage regions in the file server 4 illustrated in FIG. 2 are an example and not limited thereto. For example, the storage region may not be structured by the folders at each periodical interval, but a date when the file is output may be used as a file name. A screen for displaying the storage regions can be displayed on the user interface unit 126, a display unit (not illustrated) provided to the file server 4, or a display unit provided to an external device (not illustrated).

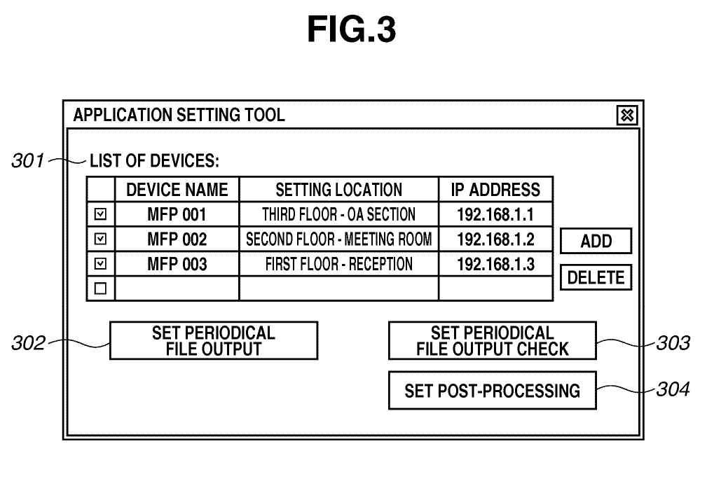

FIG. 3 illustrates an example of a tool for setting the file output. The tool is activated by an information terminal device (not illustrated). According the present exemplary embodiment, the tool for setting is described as an example on assumption of a case where the system includes a large number of the image forming apparatuses. However, the image forming apparatus may be individually set via the user interface unit 126. Appropriate setting methods can be adopted.

A device list display unit 301 is a region for displaying a list of the image forming apparatuses which are targets (management target) to be managed by the system. In the present exemplary embodiment, the image forming apparatuses 1, 2, and 3 are displayed. A method for adding the image forming apparatus to the list is not limited to the method described in the present exemplary embodiment. A method for manually adding the image forming apparatus via an addition button, or a method for automatically adding the image forming apparatus connected to the network 5 may be adopted.

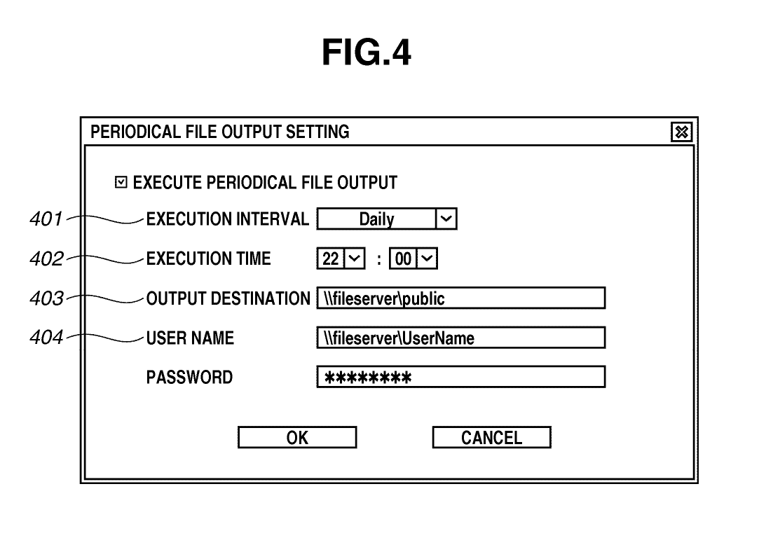

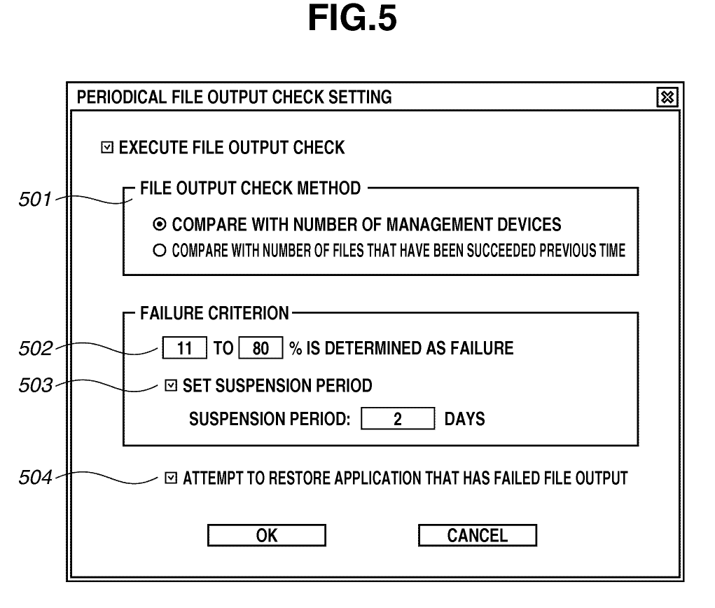

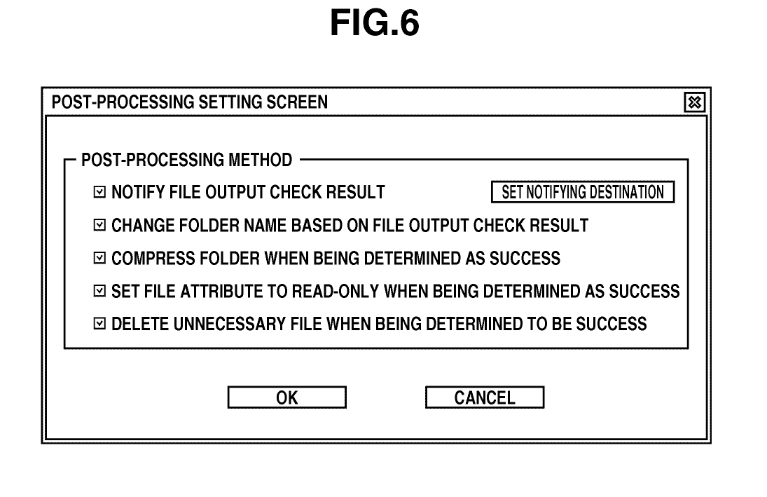

A setting button 302 for the periodical file output transfers the screen to a screen illustrated in FIG. 4 for setting the periodical file output described below. A setting button 303 for the periodical file output check transfers the screen to a screen illustrated in FIG. 5 for setting the periodical file output check described below. A setting button 304 for the post-processing transfers the screen to a screen illustrated in FIG. 6 for setting the post-processing described below.

FIG. 4 illustrates an example of a screen for setting the periodical file output. The file output unit 121 outputs the file to an output destination at each periodical interval specified via this screen.

In an execution interval specification portion 401, an interval for outputting the file, such as “Weekday”, “Daily”, “Weekly”, and “Monthly”, is specified by the user. In an execution time specification portion 402 is used for specifying time for outputting the file.

In the present exemplary embodiment, FIG. 4 illustrates the screen on which “Daily” is specified as the execution interval. Setting items can be changed according to the execution interval selected on the execution interval specification portion 401. For example, when “Weekly” is selected as the execution interval, the setting items for setting an execution day of the week and execution time are displayed. When a large number of the image forming apparatuses are the management targets, each image forming apparatus may output the file at a time which is slightly shifted from the time specified on the execution time specification portion 402, to avoid too many accesses to the file server 4 at the same time.

An output destination specification portion 403 is used for specifying the storage region (i.e. an output destination) to which the file is output. In the present exemplary embodiment, the file server 4 is specified. According to the present exemplary embodiment, the file output unit 121 generates a folder having a name representing a date when the file is output to the storage region specified by the output destination specification portion 403 when outputting the file, as necessary.

An account specification portion 404 used for specifying a user name and a password that are used for outputting the file to the storage region specified by the output destination specification portion 403.

FIG. 5 illustrates an example of a screen for setting the file output check. When the determination unit 128 determines that the file output check is performed, the file output check unit 127 performs the file output check by the file output check method specified via this screen.

A specification region 501 is used for specifying the method for checking the file output. In the present exemplary embodiment, the user can specify the method from two methods described below.
COMPARE WITH NUMBER OF MANAGEMENT DEVICES
COMPARE WITH NUMBER OF FILES THAT HAVE BEEN SUCCEEDED PREVIOUS TIME

When “COMPARE WITH NUMBER OF MANAGEMENT DEVICES” is specified, the file output check unit 127 performs the file output check by comparing the number of the files stored in the storage region with the number of the management target image forming apparatus. The number of the management target image forming apparatus is stored in the storage unit 124 of each image forming apparatus, when the setting of the file output check is performed via the screen in FIG. 5. When the settings of the file output check is performed via the screen, a file in which the number of image forming apparatuses is described may be disposed in the storage region in the file server 4, and the file output check unit 127 may read the file when performing the file output check. In an environment in which the number of the management target image forming apparatuses does not change much, the user specifies “COMPARE WITH NUMBER OF MANAGEMENT DEVICES” to perform the file output check.

When “COMPARE WITH NUMBER OF FILES THAT HAVE BEEN SUCCEEDED PREVIOUS TIME” is specified, the file output check unit 127 performs the file output check by comparing the number of the files stored in the storage region on which the file output check is performed this time with the number of the files stored in the storage region which is determined that the file output check has been successfully performed at the previous time or earlier.

For example, when the file output check is performed on the storage region, a “20090117” folder, the file output check unit 127 compares the number of the files stored in a folder, which is “20090116” or earlier and has successfully output the files, with the number of the files stored in the “20090117” folder. In an environment in which the number of the management target image forming apparatuses periodically changes, the user specifies “COMPARE WITH NUMBER OF FILES THAT HAVE BEEN SUCCEEDED PREVIOUS TIME” so that the file output check may be performed by comparing the number of the files stored in the storage region with relative values.

A specification region 502 for specifying a failure criterion is used for specifying determination of whether the periodical output is successful (or failed) when a probability (matching) for matching the number of the files of the target specified in the specification region 501 and the number of the files stored in the storage region is a certain percent or more (or less than a certain percent).

According to the present exemplary embodiment, the user can specify a maximum value and a minimum value as the matching. As the maximum value, when a strict determination is applied, a higher value (e.g., 100%) is specified and when the strict determination is not applied, a lower value is specified. For example, in an environment in which it is determined as acceptable if eight out of ten management target image forming apparatuses can output the files, the user may specify 80%.

On the other hand, by specifying the minimum value, which is an example of a threshold value, a case where the matching ratio is obviously low and it is highly likely that an error is due to the image forming apparatus which output the file can be eliminated from a case which is determined as an error in the periodical output by the file output check unit 127.

For example, although “Weekly” is specified via the execution interval specification portion 401 illustrated in FIG. 4, when one out of ten management target image forming apparatuses erroneously outputs the file on holiday, the periodical output can be avoided to be determined as a failure by specifying the minimum value. More specifically, in order to avoid exceptional determination in which it is determined as a failure since the matching ratio has an extremely low value (in this example, 10%), the minimum value (e.g., 11%) may be specified as necessary.

A suspension specification region 503 is used for specifying suspension of the determination in a case where it may be determined as a failure of the periodical output, but the file output check unit 127 does not determine that as the failure within a predetermined term, that is, during suspension.

For example, even when the file output is failed since the power of the image forming apparatus is off at the time of outputting the file, if recovery processing is available for outputting the file when the power is turned on, the recovery processing can be performed during the suspension by providing with about a two days suspended term.

Therefore, according to the specification, if the recovery processing for the file output failure is available, the file output check unit 127 can check the file output considering the recovery processing.

A restoration instruction region 504 is used for specifying whether to give an instruction to attempt restoration of the file output to the image forming apparatus that has failed the file output. When the instruction to restore is given, according to the result of the file output check, the post-processing unit 129 transmits information about a command for instantly outputting the file to the image forming apparatus that has failed the file output. With this specification, timing for performing the recovery processing for the file output can be given to the image forming apparatus that has failed the file output, so that the restoration can be performed depending on a cause of the failure.

FIG. 6 illustrates an example of a screen for setting the post-processing. The post-processing unit 129 performs the post-processing using a post-processing method specified via the screen after the file output check has been performed. According to the present exemplary embodiment, the user can specify a method out of five methods described below.
NOTIFY FILE OUTPUT CHECK RESULT
CHANGE FOLDER NAME BASED ON FILE OUTPUT CHECK RESULT
COMPRESS FOLDER WHEN BEING DETERMINED AS SUCCESS
SET FILE ATTRIBUTE TO READ-ONLY WHEN BEING DETERMINED AS SUCCESS
DELETE UNNECESSARY FILE WHEN BEING DETERMINED AS SUCCESS

When “NOTIFY FILE OUTPUT CHECK RESULT” is specified, the post-processing unit 129 notifies a notification destination (mail address) specified using a notification setting button via a screen for setting the notification destination (not illustrated) of a result of the file output check. With this configuration, for example, by specifying the notification destination of a manager of the image forming apparatus 1, the manager can check the result of the file output without checking the file server 4.

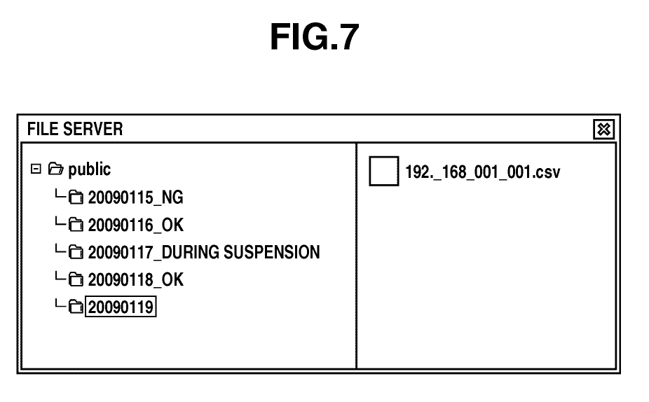

When “CHANGE FOLDER NAME BASED ON FILE OUTPUT CHECK RESULT” is specified, the post-processing unit 129 changes a folder name of the file server 4 based on the result of the file output check (refer to FIG. 7). According to the configuration for changing the folder name, the user can determine whether the periodical output is successful without checking the files in the folder.

When “COMPRESS FOLDER WHEN BEING DETERMINED AS SUCCESS” is specified, the post-processing unit 129 compresses the folder when the periodical output is determined to be successful. With the configuration, a consumption capacity in the storage region (i.e. a disk) of the file server 4 can be suppressed.

When “SET FILE ATTRIBUTE TO READ-ONLY WHEN BEING DETERMINED AS SUCCESS” is specified, the post-processing unit 129 sets the attribute of the file stored in the folder to read-only when the periodical output is determined to be successful. With this configuration, the files can be prevented from being falsified as much as possible.

When “DELETE UNNECESSARY FILE WHEN BEING DETERMINED AS SUCCESS” is specified, the post-processing unit 129 deletes unnecessary files having no meaning in the folder when the periodical output is determined to be successful. When there is no history of image processing performed by the image forming apparatus, the file having no contents may be output. By deleting the files having no meaning, only necessary files can be stored in the file server 4.

FIG. 7 illustrates an example of a screen when the post-processing “CHANGE FOLDER NAME BASED ON FILE OUTPUT CHECK RESULT” is performed after the file output check has been performed on the file server 4.

When the image forming apparatus 1 outputs the file into a “20090119” folder, since the image forming apparatus in which the determination unit 128 is included satisfies a condition “An image forming apparatus that has first output the file during the periodical file output of the present time”, the determination unit 128 determines to perform the file output check. According to a result of the file output check performed on a “20090118” folder, all image forming apparatuses have output the files thereinto. Thus, the post-processing unit 129 changes the folder name to “20090118_OK”.

According to the result of the file output check performed on the folders earlier than the “20090118” folder, for example, the file output check performed on a “20090115” folder is determined to be failed. Thus, the post-processing unit 129 changes the folder name to “20090115_NG”.

Regarding a “20090117” folder, according to the result of the file output check, the file output is determined to be failed. However, since “two days” is set as a suspended term, the post-processing unit 129 does not change the folder name from “20090117” to “20090117_NG” but to “20090117_during suspension” in two days.

Therefore, as illustrated in FIG. 7, the user can check whether the periodical output is successful only by viewing the storage region (display portion). Regarding notation of the folder name for facilitating the check of success, in other words, for recognizing the result of the check, terms or symbols (e.g., “O” or “X”) other than “OK” or “NG” as described above may be used.

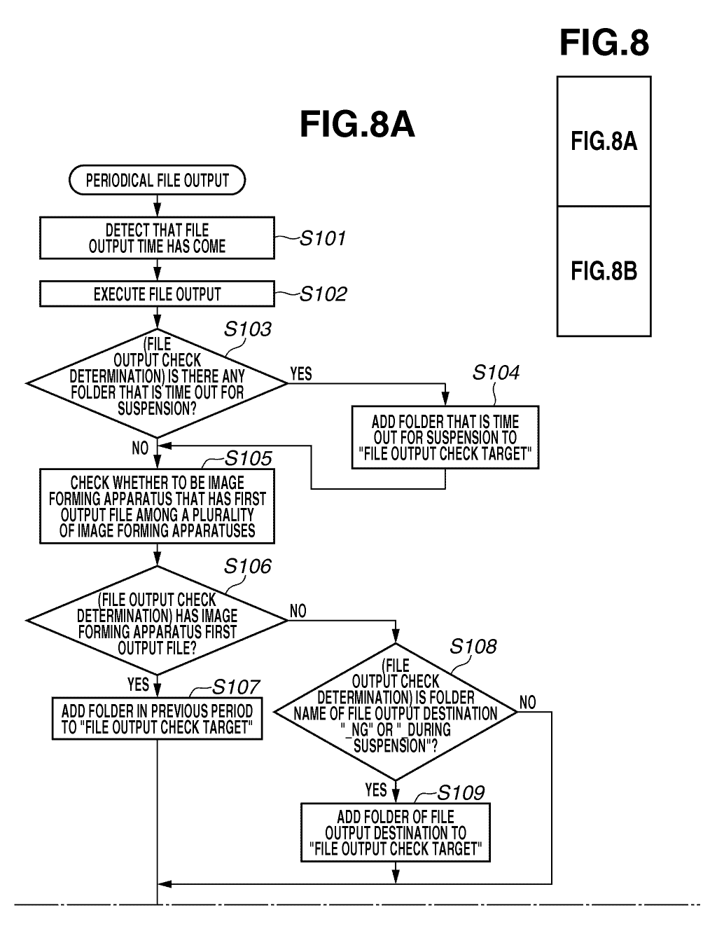

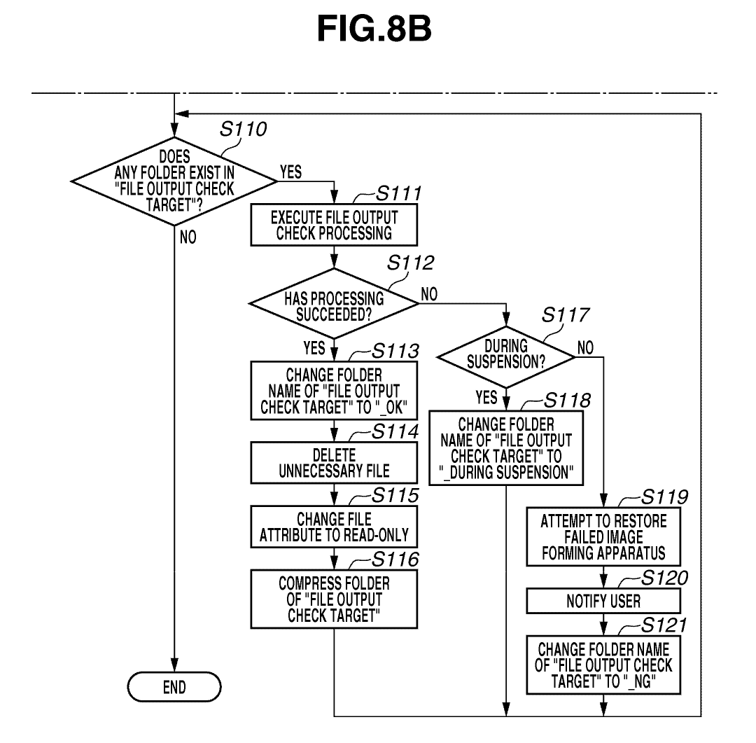

FIG. 8 (including FIG. 8A and FIG. 8B) is a flowchart illustrating an example of processing performed by the application unit 11 when outputting the file.

In step S101, the schedule management unit 122 detects that a time for outputting the file has come. In step S102, the file output unit 121 outputs the file into the storage region in the file server 4 set via the screen illustrated in FIG. 4. When the file is output, if a folder having a name that represents a current date does not exist, the file output unit 121 generates a folder and outputs the file into the generated folder.

In step S103, the determination unit 128 performs the file output check determination to determine whether the image forming apparatus in which the determination unit 128 is included is to perform the file output check. More specifically, the determination unit 128 checks whether there exists any folder having a name including “during suspension” in the storage region in the file server 4. When the folder exists (YES in step S103), the date and time when the folder was generated is compared with the current date and time to check whether the suspended term specified via the screen illustrated in FIG. 5 has elapsed.

In other words, the determination unit 128 checks whether a predetermined term has elapsed on the term checked by the image forming apparatus 127. When a suspension-expired folder exists (YES in step S103), then in step S104, the determination unit 128 determines that the file output check is performed and specifies the suspension-expired folder to a “file output check target”.

Accordingly, an arbitrary image forming apparatus automatically detects the suspension-expired folder and can perform the file output check again. On the other hand, when there is no suspension-expired folder (NO in step S103), the determination unit 128 sequentially performs processing in step S105.

In step S105, the determination unit 128 checks an order that the image forming apparatus in which the determination unit 128 is included outputs the file among the plurality of image forming apparatuses, and more specifically, checks whether the image forming apparatus has first output the file. Further, more specifically, the determination unit 128 checks whether the image forming apparatus has first output the file by determining whether the file output unit 121 generates the folder of the current date in step S102.

In step S106, the determination unit 128 determines whether the image forming apparatus has first output the file.

When the image forming apparatus has first output the file (YES in step S106), then in step S107, the determination unit 128 determines that the image forming apparatus is to perform the file output check and specifies the folder for the previous term as the “file output check target”.

For example, when “Daily” is specified for a execution interval illustrated in FIG. 4, the determination unit 128 specifies the folder for the previous day, which is the folder for the previous term, as the “file output check target”. More specifically, when the image forming apparatus in which the determination unit 128 is included first outputs the file, among the plurality of image forming apparatuses, to a second storage region, which is an output destination of a following file to be output after the file is output to the first storage region, the determination unit 128 determines to check whether the periodical output to the first storage region has been successful. According to the present exemplary embodiment, whether the image forming apparatus has first output the file is determined by the generated folder, however the method is not limited to the method described above.

On the other hand, when it is determined that the image forming apparatus has not first output the file (NO in step S106), then in step S108, the determination unit 128 checks whether the folder name of the output destination to which the file is output this time includes “_NG”, or “_during suspension”.

When the folder name includes “_NG”, or “_during suspension” (YES in step S108), then in step S109, the determination unit 128 determines to perform the file output check on the folder described above, and specifies the folder into which the file is output this time as the “file output check target”.

Accordingly, when the image forming apparatus performs certain recovery processing and outputs the file to the folder that has been failed in the past, if the folder has been already determined to have been failed, the file output check can be performed again and a new result of the file output check can be reflected thereon. On the other hand, when the folder name does not include “_NG”, or “_during suspension” (NO in step S108), the determination unit 128 then performs processing in step S110.

In step S110, the file output check unit 127 checks whether there exists any folder on which the file output check is to be performed via step S104, S107, or S109 as the “file output check target”. When the folder exists (YES in step S110), in step S111, the file output check unit 127 performs the file output check on the folder. When no folder exists (NO in step S110), the processing is ended.

In step S112, according to the result of the file output check, the file output check unit 127 determines whether the periodical output is successful. When it is determined that the periodical output is successful (YES in step S112), then in step S113, the post-processing unit 129 changes the name of the folder on which the file output check has been performed by adding “_OK” according to the settings displayed on the screen illustrated in FIG. 6.

In step S114, the post-processing unit 129 deletes unnecessary files according to the settings displayed on the screen illustrated in FIG. 6. In step S115, the post-processing unit 129 changes the file attribute to read-only. In step S116, the post-processing unit 129 compresses capacities of the folders.

On the other hand, when it is determined that the periodical output is failed (NO in step S112), then in step S117, the file output check unit 127 refers to the current date and time and the suspended term to check whether the current date and time is within the suspended term.

When the current date and time is within the suspended term (during the suspension) (YES in step S117), then in step S118, the post-processing unit 129 changes the folder name by adding “_during suspension” according to the settings displayed on the screen illustrated in FIG. 6.

On the other hand, when the current date and time is out of the suspended term (NO in step S117), then in step S119, the file output check unit 127 attempts the restoration processing, for example requesting the file output, on the image forming apparatus that has failed the periodical output. When the restoration processing is not performed, in step S120, the post-processing unit 129 notifies the user of the result of the file output check according to the settings on the screen illustrated in FIG. 6. Then in step S121, the folder name is changed by adding “_NG”.

Then the processing returned to step S110, and the above described processing is repeatedly performed until the file output can be checked on all the “file output check targets”.

The respective application units 11 of the plurality of image forming apparatuses perform the file output check determination in steps S103, S106, and S108 when outputting the files. With this configuration, even if one image forming apparatus is in an abnormal state, other image forming apparatuses can check the file output.

Further, according to the configuration of the present exemplary embodiment, the image forming apparatus determined to be within the suspended term in step S117 may be different from the image forming apparatus determined to be out of the suspended term in step S103. Thus, even when the image forming apparatus determined to be within the suspended term is in the abnormal state, determination of whether the suspended term is expired can be performed on another image forming apparatus not in the abnormal state.

Therefore, according to the configuration described above, without providing with an application specialized for monitoring whether the periodical output is successful, the failure of the periodical output can be detected. Further, even one image forming apparatus is in the abnormal state, another image forming apparatus can detect the failure of the periodical output.

The present invention can also be realized by executing the following process. That is, a process in which a software (program) that realizes the functions of the above-described embodiments is supplied to the system or apparatus via a network or a recording medium of various types, and then a computer of the system or apparatus (or devices such as CPU or MPU) reads out the program and executes it. In such a case, the recording medium where the program is stored as well as the program are included in the present invention.

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures, and functions.

This application claims priority from Japanese Patent Application No. 2009-198784 filed Aug. 28, 2009, which is hereby incorporated by reference herein in its entirety.

What is claimed is:

1. An apparatus comprising:
an output unit configured to periodically output a file to a storage region of a storage device and to share the storage region with another apparatus;
a check unit configured to check whether the periodical output of the file performed by a plurality of apparatuses is successful based on a number of the files stored in the storage region; and
a post-processing unit configured to perform post-processing based on a result of the check performed by the check unit.

2. The apparatus according to claim 1, wherein the check unit checks whether the periodical output is successful by comparing a number of the plurality of apparatuses that are to output the file to the storage region with the number of the files stored in the storage region.

3. The apparatus according to claim 1, wherein the check unit checks whether the periodical output is successful by comparing a number of the files stored when a check unit of any of the plurality of apparatuses has checked that the periodical output has been successful in a past with the number of the files stored in the storage region.

4. The apparatus according to claim 1, wherein the check unit checks whether the periodical output is successful based on the number of the files stored in the storage region using previously set threshold values.

5. The apparatus according to claim 1, wherein the check unit suspends to check whether the periodical output is successful when a term for checking whether the periodical output is successful is within a predetermined term.

6. The apparatus according to claim 1, further comprising a determination unit configured to determine whether the apparatus is an apparatus to check whether the periodical output to a first storage region that is an output destination to which the plurality of apparatuses output the file is successful,
wherein, when the apparatus first outputs the file to a second storage region which is an output destination of the periodical file output performed after the files have been output to the first storage region among the plurality of apparatuses, the determination unit determines that the apparatus checks whether the periodical output to the first storage region is successful.

7. The apparatus according to claim 6, wherein when the output unit outputs the file to the storage region where a check unit of any of the plurality of apparatus has already checked whether the periodical output has been successful, the determination unit determines whether the apparatus includes the check unit for checking whether the periodical output is successful.

8. The apparatus according to claim 6, wherein when a predetermined term has elapsed on a term during which the check unit checks whether the periodical output is successful, the determination unit determines that the apparatus is an apparatus to check whether the periodical output is successful.

9. The apparatus according to claim 1, wherein the post-processing unit notifies a user of the result of the check.

10. The apparatus according to claim 1, wherein the post-processing unit changes, based on the result of the check, a name of the storage region by which the result of the check can be recognized.

11. The apparatus according to claim 1, wherein the post-processing unit compresses a capacity of the storage region based on the result of the check.

12. The apparatus according to claim 1, wherein the post-processing unit changes an attribute of a file stored in the storage region to read-only based on the result of the check.

13. The apparatus according to claim 1, wherein when unnecessary files exist in the storage region, the post-processing unit deletes the unnecessary files based on the result of the check.

14. The apparatus according to claim 1, wherein, based on the result of the check, the post-processing unit requests another apparatus among the plurality of apparatuses that has not output the file to the storage region to output the file.

15. The apparatus according to claim 1, wherein the file includes history information corresponding to image forming processing performed by the apparatus.

16. A method for forming an image performed by an apparatus, the method comprising:
periodically outputting a file to a storage region of a storage device, the storage region being shared with another apparatus;
checking whether a periodical output of the file to the storage region performed by a plurality of apparatuses is successful based on a number of the files stored in the storage region; and
performing post-processing based on a checked result.

17. The method according to claim 16, further comprising:
determining whether the apparatus is an apparatus to check whether the periodical output to a first storage region that is an output destination to which a plurality of apparatuses output the file is successful;
outputting the file to a second storage region which is an output destination of the periodical file output performed after the files have been output to the first storage region among the plurality of apparatuses; and
determining that the apparatus checks whether the periodical output to the first storage region is successful.

18. A computer readable storage medium on which is stored a computer program for making a computer execute a method for an apparatus, the method comprising:
periodically outputting a file to a storage region of a storage device, the storage region being shared with another apparatus;
checking whether a periodical output of the file to the storage region performed by a plurality of is successful based on a number of the files stored in the storage region; and
performing post-processing based on a checked result.

19. The computer readable storage medium according to claim 18, further comprising:
determining whether the apparatus is an apparatus to check whether the periodical output to a first storage region that is an output destination to which a plurality of apparatuses output the file is successful;
outputting the file to a second storage region which is an output destination of the periodical file output performed after the files have been output to the first storage region among the plurality of apparatuses; and
determining that the apparatus checks whether the periodical output to the first storage region is successful.
